(19) United States
(12) Patent Application Publication
(10) Pub. No.: US 2026/0211260 A1
(43) Pub. Date: Jul. 23, 2026

(54) DISPLAY APPARATUS AND DISPLAY METHOD

(71) Applicant: JVCKENWOOD Corporation, Yokohama-shi (JP)

(72) Inventor: Fumihiko ITO, Yokohama-shi (JP)

(21) Appl. No.: 19/571,563

(22) Filed: Mar. 19, 2026

Related U.S. Application Data
(63) Continuation of application No. PCT/JP2024/027590, filed on Aug. 1, 2024.

(30) Foreign Application Priority Data
Sep. 22, 2023 (JP) 2023-158144
Sep. 22, 2023 (JP) 2023-158145

(51) Int. Cl. G02B 30/10; G02B 26/08; G02B 26/10; G02B 27/00; G02B 30/23

(52) U.S. Cl. CPC G02B 30/10; G02B 26/0816; G02B 26/0875; G02B 26/101; G02B 27/0025; G02B 30/23

(57) ABSTRACT

A display apparatus includes: a display body that contains a phosphor; a light source that outputs an excitation light to excite the phosphor; a first lens and a second lens that focus the excitation light on a focal position inside the display body; a first drive mechanism that drives the first lens to vary the focal position; and a second drive mechanism that drives the second lens to reduce aberration that varies with a change in the focal position.

### CROSS REFERENCE TO RELATED APPLICATION

This application is a continuation of application No. PCT/JP2024/027590, filed on August 1, 2024, and claims the benefit of priority from the prior Japanese Patent Applications No.2023-158144, filed on September 22, 2023 and No.2023-158145, filed on September 22, 2023, the entire contents of which are incorporated herein by reference.

### BACKGROUND

### 1. Technical Field

The present disclosure relates to a display apparatus and a display method.

### 2. Description of the Related Art

As a display apparatus for stereoscopic images, a configuration has been proposed to irradiate a display body containing a phosphor with an ultraviolet light and draw a stereoscopic image inside the display body by varying the position irradiated by the ultraviolet light (see, for example, patent literature 1).

Patent literature 1 JP2015-165611A

It is preferable to be able to display stereoscopic images with higher definition.

### SUMMARY

A display apparatus according to an embodiment of the present disclosure includes: a display body that contains a phosphor; a light source that outputs an excitation light to excite the phosphor; a first lens and a second lens that focus the excitation light on a focal position inside the display body; a first drive mechanism that drives the first lens to vary the focal position; and a second drive mechanism that drives the second lens to reduce aberration that varies with a change in the focal position.

A display apparatus according to another embodiment of the present disclosure includes: a display body that contains a phosphor and has a concave surface; a light source that outputs an excitation light to excite the phosphor; a scan mirror that reflects the excitation light toward the concave surface; and a mirror drive mechanism that varies an incidence position of the excitation light on the concave surface by driving the scan mirror.

Still another embodiment of the present disclosure relates to a display method. The method includes: focusing an excitation light to excite a phosphor on a focal position inside a display body that contains the phosphor by using a first lens and a second lens; driving the first lens to vary the focal position; and driving the second lens to reduce aberration that varies with a change in the focal position.

Yet another embodiment of the present disclosure relates to a display method. The method includes: reflecting an excitation light to excite a phosphor toward a concave surface of a display body that contains the phosphor; and driving the scan mirror to vary an incidence position of the excitation light on the concave surface.

Optional combinations of the aforementioned constituting elements, and mutual substitution of constituting elements and implementations of the present disclosure between methods, apparatuses, systems, etc. may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 schematically shows a configuration of a display apparatus according to the first embodiment;

FIG. 2 is a graph showing an example of spherical aberration determined by the focal position according to an exemplary embodiment and a comparative example;

FIG. 3 is a graph showing an example of the spot diameter of the excitation light determined by the focal position according to the exemplary embodiment and the comparative example;

FIG. 4 schematically shows a configuration of a display apparatus according to the second embodiment;

FIG. 5 schematically shows a configuration of a display apparatus according to the third embodiment;

FIG. 6 is a graph showing an example of coma aberration determined by the focal position according to the exemplary embodiment and the comparative example; and

FIG. 7 is a graph showing an example of the spot diameter of the excitation light determined by the focal position according to the exemplary embodiment and the comparative example.

### DETAILED DESCRIPTION

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration. To facilitate the understanding, the relative dimensions of the constituting elements in the drawings do not necessarily mirror the actual relative dimensions.

### First embodiment

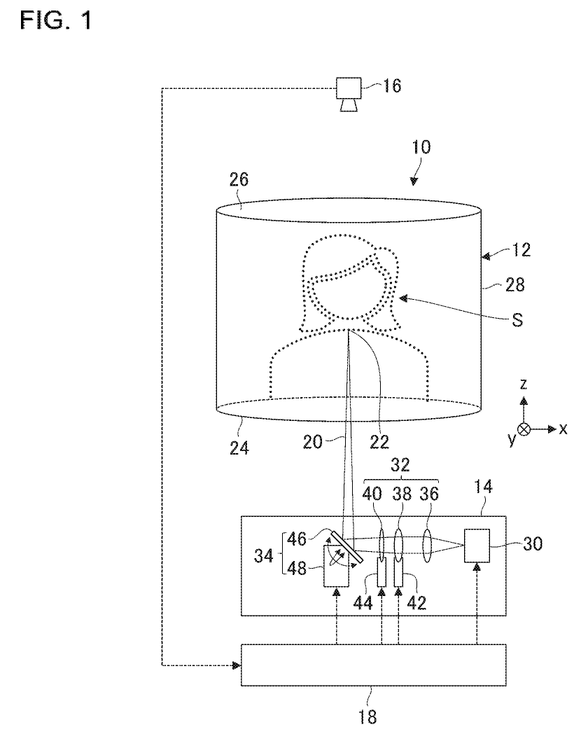

FIG. 1 schematically shows a configuration of a display apparatus 10 according to the first embodiment. The display apparatus 10 is equipped with a display body 12, an irradiation unit 14, a sensor 16, and a control unit 18. The display apparatus 10 is a so-called volume display and is configured to draw a stereoscopic image S inside the display body 12.

The display body 12 includes a phosphor that is irradiated by an excitation light 20 to emit light. The phosphor has an excitation wavelength in the ultraviolet light range and an emission wavelength in the visible light range. The phosphor material is not particularly limited. For example, the phosphor is a quantum dot phosphor in which is used cesium lead halide perovskite (CsPbX3, where X denotes a halogen and is one of Cl, Br, I or is a mixture thereof) or a rare earth phosphor in which is used a rare earth element such as europium (Eu), cerium (Ce), and yttrium (Y).

The display body 12 is comprised of, for example, a medium that is transparent to visible light and a phosphor dispersed in the medium. The medium can be a solid such as resin and glass. Alternatively, the medium can be a liquid such as toluene. Alternatively, the medium can be a gas. In the case the medium is a liquid or a gas, the display body 12 may be equipped with a transparent container for accommodating the medium. The transparent container may be made of a resin material or a glass material. The display body 12 includes a transparent solid material and so has a portion with a higher refractive index than the surroundings of the display body 12 (e.g., air).

The display body 12 is equipped with a first surface 24, a second surface 26, and a side surface 28. The first surface 24 is a surface on which the excitation light 20 is incident. The second surface 26 is a surface opposite to the surface on which the excitation light 20 is incident. The side surface 28 extends from the first surface 24 to the second surface 26. The first surface 24, the second surface 26, and the side surface 28 are made of a material with a higher refractive index than the surroundings (e.g., air) and are made of, for example, a resin or a glass material.

The display body 12 is configured to have, for example, a columnar shape and is configured to have a cylindrical shape, a polygonal column shape, or a cuboid shape. The display body 12 shown in FIG. 1 is cylindrical in shape. The display body 12 is configured in such a way that the surface of the display body 12 (the first surface 24, the second surface 26, and the side surface 28) has a mirror finish so that the interior of the display body 12 can be seen from outside.

The size of the display body 12 is not particularly limited. For example, the size in the height direction (the z direction) from the first surface 24 to the second surface 26 can be about 100 mm–1000 mm, and the size in the directions orthogonal to the height direction (the x and y directions) can be about 100 mm–1000 mm. By way of example, the size of the display body 12 in the x, y, and z directions can be 500 mm.

The irradiation unit 14 irradiates the display body 12 with the excitation light 20 to excite the phosphor contained in the display body 12. The excitation light 20 is incident on the first surface 24 of the display body 12 and is focused on a focal position 22 inside the display body 12. The excitation light 20 is radiated in such a way that the focal position 22 inside the display body 12 changes over time. The irradiation unit 14 is equipped with a light source 30, a condensing optical system 32, and a scanning optical system 34.

The light source 30 produces the excitation light 20 for exciting the phosphor contained in the display body 12. The light source 30 produces, for example, an ultraviolet light with a center wavelength in a range of 300 nm–400 nm as the excitation light 20. The type of the light source 30 does not matter. For example, a gallium nitride (GaN) based semiconductor laser or a semiconductor LED (Light Emitting Diode) can be used as the light source 30.

The condensing optical system 32 condenses the excitation light 20 produced by the light source 30 toward the interior of the display body 12. The condensing optical system 32 varies the focal position 22 in the irradiation direction of the excitation light 20 and makes the focal position 22 in the direction intersecting the first surface 24 variable. The condensing optical system 32 is equipped with a collimating lens 36, a first lens 38, a second lens 40, a first drive mechanism 42, and a second drive mechanism 44.

The collimating lens 36 parallelizes the excitation light 20 produced by the light source 30. The first lens 38 condenses the excitation light 20 parallelized by the collimating lens 36 toward the interior of the display body 12. The first lens 38 is a variable focus lens and is driven by the first drive mechanism 42 such that its focal length is variable. The second lens 40 corrects the aberration (e.g., spherical aberration) caused at the focal position 22 and reduces the aberration. The second lens 40 is a variable focal length lens and is driven by the second drive mechanism 44 such that its focal length is variable. The positions of the first lens 38 and the second lens 40 on the optical axis are fixed.

The variable focus lens used as the first lens 38 or the second lenses 40 is comprised of, for example, a liquid lens whose focal length is made variable by deforming a flexible transparent film that encapsulates the liquid lens. The shape of the transparent film is controlled by varying the pressure applied to the transparent film. The first drive mechanism 42 or the second drive mechanism 44 is, for example, an electromagnetic actuator or a piezoelectric element that applies a pressure to the transparent film and electrically controls the focal length of the variable focus lens by varying the pressure.

The first lens 38 acts as a condensing lens for focusing a parallel light at the focal position 22. The first lens 38 provides a greater positive refractive power compared to the second lens 40. The first lens 38 provides, for example, a variable refractive force required to vary the focal position 22 (focus position) of the excitation light 20 over the range from the first surface 24 to the second surface 26. Given that the distance along the optical axis from the first lens 38 to the first surface 24 is 200 mm, and the height from the first surface 24 to the second surface 26 is 500 mm, by way of example, the focal length of the first lens 38 is configured to be variable in a range from 200 mm to 700 mm in air equivalent.

The second lens 40 functions as an aberration correction lens to reduce the aberration caused by the refraction of the excitation light 20 on the first surface 24. Since the display body 12 has a higher refractive index than the surroundings (e.g., air), the refraction of the excitation light 20 on the first surface 24 causes an over-spherical aberration at the focal position 22. The magnitude of this spherical aberration varies with the transmission distance (optical path length) of the excitation light 20 inside the display body 12, and the spherical aberration tends to increase as the transmission distance increases. As a result, the required aberration correction amount varies according to the focal position 22 of the excitation light 20. The second lens 40 reduces the spherical aberration determined by the focal position 22 by varying the focal length according to the focal position 22. By reducing the aberration at the focal position 22, the spot diameter of the excitation light 20 at the focal position 22 can be reduced, and the stereoscopic image S can be drawn with higher definition. The second lens 40 provides a smaller positive refractive force compared to the first lens 38. In the case of the above example, the focal length of the second lens 40 is configured to be 3000 mm or more and to be variable.

The scanning optical system 34 directs the excitation light 20 that has passed through the condensing optical system 32 for a scan and varies the focal position 22 of the excitation light 20 in the directions (the x and y directions) along the first surface 24. The scanning optical system 34 is equipped with a scan mirror 46 and a mirror drive mechanism 48. The scan mirror 46 reflects the excitation light 20 toward the first surface 24 of the display body 12. The mirror drive mechanism 48 is configured to vary the orientation of the scan mirror 46 in two axes. In the illustrated example, a single scan mirror 46 is used, but the first scan mirror for scanning in the x-direction and the second scan mirror for scanning in the y-direction may be combined.

The sensor 16 is arranged around the display body 12 and is configured to detect the focal position 22. The sensor 16 is a two-dimensional photodetector such as a CCD sensor and a CMOS sensor. For example, the sensor 16 is a camera that images the display body 12. The sensor 16 is, for example, positioned to face the second surface 26 of the display body 12. The position of the sensor 16 does not particularly matter, and the sensor 16 may be positioned to face the side surface 28 of the display body 12 or may be positioned at an angle to the display body 12.

The control unit 18 controls the operation of the irradiation unit 14. The control unit 18 may be implemented by a combination of hardware and software. The hardware of the control unit 18 may be implemented by devices and mechanical apparatus exemplified by a processor such as a CPU (Central Processing Unit) and a GPU (Graphics Processing Unit) and by a memory such as a ROM (Read Only Memory) and a RAM (Random Access Memory). The software of the control unit 18 may be implemented by a computer program, etc. In this case, the control unit 18 is depicted as a functional block implemented by cooperation of hardware and software. It will be understood by those skilled in the art that the functional blocks of the control unit 18 can be implemented in a variety of manners by a combination of hardware and software.

The control unit 18 controls the focal position 22 of the excitation light 20 in three dimensions (the x, y, and z directions) by controlling the operation of the first drive mechanism 42 and the mirror drive mechanism 48. The control unit 18 directs the focal position 22 of the excitation light 20 inside the display body 12 for a three-dimensional scan by causing the first drive mechanism 42 and the mirror drive mechanism 48 to operate periodically.

The control unit 18 reduces the aberration determined by the focal position 22 of the excitation light 20 and reduces the spot diameter of the excitation light 20 at the focal position 22 by controlling the operation of the second drive mechanism 44. The control unit 18 stores table information mapping the focal position 22, the first driving quantity of the first drive mechanism 42, and the second driving quantity of the second drive mechanism 44 to each other and drives the first drive mechanism 42 and the second drive mechanism 44 according to the table information.

The control unit 18 may control the operation of at least one of the first drive mechanism 42 or the second drive mechanism 44 based on the detection result of the sensor 16 detecting the focal position 22. The control unit 18 may, for example, drive the second drive mechanism 44 to minimize the spot diameter of the excitation light 20 at the focal position 22. The control unit 18 may vary the first driving quantity in steps, detect the spot diameter of the excitation light 20 for each first driving quantity using the sensor 16, and determine the second driving quantity that minimizes the spot diameter of the excitation light 20.

The control unit 18 may store the combination of the first driving quantity and the second driving quantity thus determined as table information and may drive the first drive mechanism 42 and the second drive mechanism 44 according to the table information thus stored.

The control unit 18 controls on/off of the light source 30 according to the focal position 22 of the excitation light 20. The control unit 18 turns on the light source when the focal position 22 of the excitation light 20 is a point that should be drawn inside the display body 12. The control unit 18 turns off the light source when the focal position 22 of the excitation light 20 is not a point that should be drawn inside the display body 12. The control unit 18 controls, for example, on-off of the light source 30 and the luminous intensity of the light source 30 based on stereoscopic outline image data produced from three-dimensional image data. The stereoscopic outline image data is data designating the three-dimensional position of the outline of the stereoscopic image S that should be drawn in the display body 12.

A description will now be given of the operation of the display apparatus 10. The control unit 18 acquires the stereoscopic outline image data and causes the irradiation unit 14 to operate based on the stereoscopic outline image data. The control unit 18 controls the operation of the first drive mechanism 42, the second drive mechanism 44, and the mirror drive mechanism 48, directs the focal position 22 of the excitation light 20 inside the display body 12 for a three-dimensional scan, and reduces the aberration determined by the focal position 22.

The control unit 18 controls the output intensity of the light source 30 according to the focal position 22 of the excitation light 20 to realize display specified by the stereoscopic outline image data for each drawing position. This allows the stereoscopic image S corresponding to the stereoscopic outline image data to be drawn inside the display body 12. The control unit 18 may acquire the stereoscopic outline image data corresponding to each frame of video data to draw different stereoscopic images S frame by frame. In this way, the stereoscopic image S that is a video may be displayed.

The display method according to the embodiment includes a step of focusing the excitation light 20 on the focal position 22 inside the display body 12 using the first lens 38 and the second lens 40, a step of driving the first lens 38 to vary the focal position 22, and a step of driving the second lens 40 to reduce the aberration that varies with a change in the focal position 22.

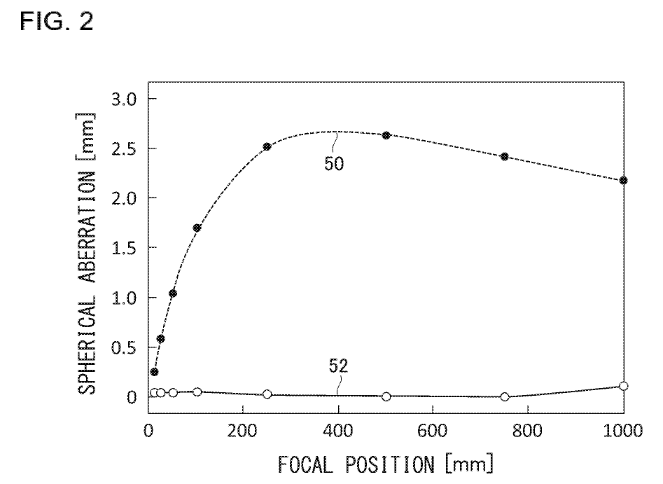

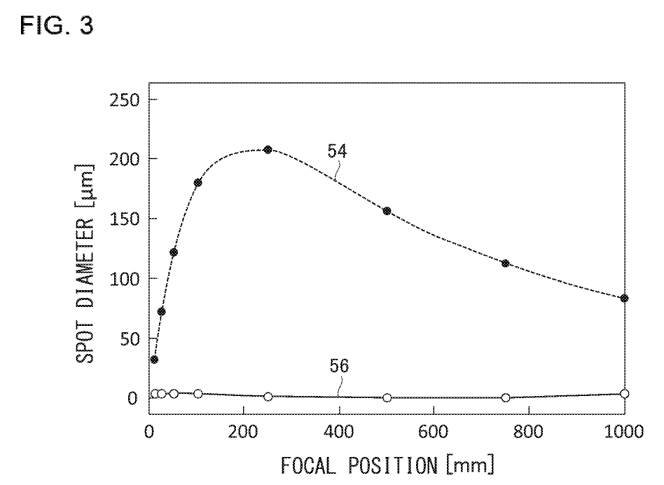

A description will now be given of advantages of the embodiment. FIG. 2 is a graph showing an example of spherical aberration determined by the focal position 22 according to an exemplary embodiment and a comparative example. FIG. 3 is a graph showing an example of the spot diameter of the excitation light 20 determined by the focal position 22 according to the exemplary embodiment and the comparative example. The exemplary embodiment is presented as a case where the second lens 40 is provided to correct the aberration, and the comparative example is presented as a case where the second lens 40 to correct the aberration is not provided. In the exemplary embodiment and the comparative example, the wavelength of the excitation light 20 is 405 nm, the beam diameter of the excitation light 20 parallelized by the collimating lens 36 is 200 mm, the distance along the optical axis from the first lens 38 to the first surface 24 of the display body 12 is 260 mm, and the refractive index of the display body 12 is 1.51. In the exemplary embodiment, the distance from the first lens 38 to the second lens 40 is 30 mm.

FIG. 2 shows the maximum value of spherical aberration caused at the focal position 22. The horizontal axis of the graph represents the position in the depth direction from the first surface 24 toward the second surface 26 when it is given that the position of the first surface 24 of the display body 12 is 0 mm. In the comparative example indicated by a dashed line 50, it is seen that the amount of aberration increases as the focal position 22 deepens.

It will be noted that the amount of aberration does not increase monotonously as the focal position 22 deepens but shows a tendency to decrease after reaching the maximum at the position where the focal position 22 is about 300 mm–400 mm. This is thought to be due to the fact that the spherical aberration is proportional to the cube of the aperture (NA) of the excitation light 20 so that the deeper focal position 22 and smaller NA has an impact of reducing the amount of aberration. In the exemplary embodiment indicated by a solid line 52, on the other hand, it is seen that the amount of aberration is reduced to 0.1 mm or less regardless of the focal position 22, indicating that the aberration is suitably reduced. In particular, the amount of aberration can be reduced to 0.05 mm or less in a range where the focal position 22 is 750 mm or less.

FIG. 3 shows the spot diameter (RMS, root mean square) of the excitation light 20 at the focal position 22. The horizontal axis of the graph represents, as in the case of FIG. 2, the position in the depth direction from the first surface 24 toward the second surface 26 when it is given that the position of the first surface 24 of the display body 12 is 0 mm. I the comparative example indicated by a dashed line 54, it is seen that the spot diameter increases as the focal position 22 deepens. It will be noted that the spot diameter does not increase monotonically as the focal position 22 deepens but shows a tendency to decrease after reaching a maximum at the position where the focal position 22 is about 250 mm. The focal position 22 at about 250 mm could occur near the center of the display body 12. In the case the spot diameter near the center of the display body 12 is about 200 μm, it could be difficult to draw the stereoscopic image S with high definition, resulting in a blurry and unclear stereoscopic image S. In the exemplary embodiment indicated by a solid line 56, on the other hand, the spot diameter is controlled to be 2 μm or less, which is close to the diffraction limit, regardless of the focal position 22. This makes it possible to draw the stereoscopic image S with high definition and display a clearer stereoscopic image S compared to the comparative example.

### Second embodiment

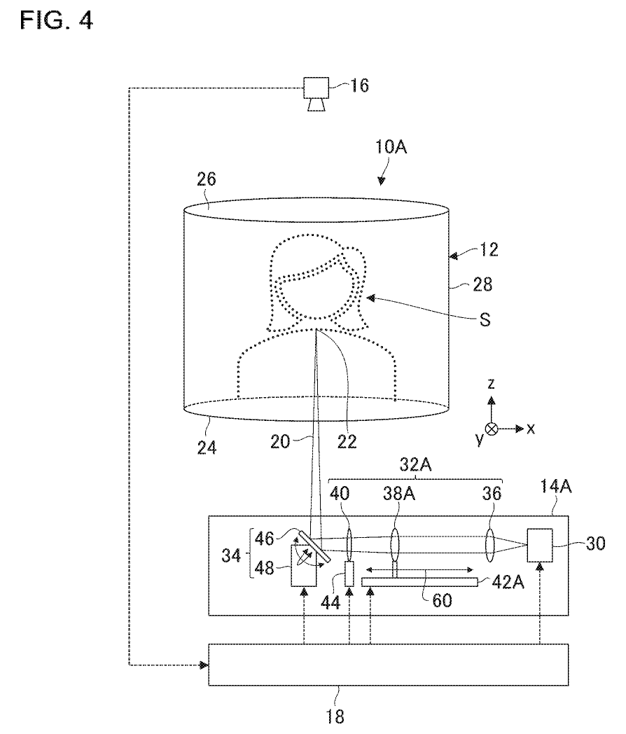

FIG. 4 schematically shows a configuration of a display apparatus 10A according to the second embodiment. The second embodiment differs from the first embodiment described above in that a first lens 38A is not a variable focus lens but is a fixed focus lens that can be moved in an optical axis direction 60. The following description of the second embodiment highlights the difference from the first embodiment, and a description of common features is omitted as appropriate.

The display apparatus 10A is equipped with the display body 12, an irradiation unit 14A, the sensor 16, and the control unit 18. The display body 12, the sensor 16, and the control unit 18 may be configured similarly to the first embodiment described above.

The irradiation unit 14A is equipped with the light source 30, a condensing optical system 32A, and the scanning optical system 34. The light source 30 and the scanning optical system 34 may be configured similarly to the first embodiment described above. The condensing optical system 32A is equipped with the collimating lens 36, a first lens 38A, the second lens 40, a first drive mechanism 42A, and a second drive mechanism 44. The collimating lens 36, the second lens 40 and the second drive mechanism 44 may be configured similarly to the first embodiment described above.

The first lens 38A condenses the excitation light 20 parallelized by the collimating lens 36 toward the interior of the display body 12. The first lens 38A is a fixed focus lens and is driven by the first drive mechanism 42A to make its position in the optical axis direction 60. The first drive mechanism 42A is configured to vary the position of the first lens 38A in the optical axis direction 60. The first drive mechanism 42A varies the focal position 22 of the excitation light 20 by varying the position of the first lens 38A. The first drive mechanism 42A makes the focal position 22 in the irradiation direction of the excitation light 20 variable and makes the focal position 22 in the direction intersecting the first surface 24 variable.

The second lens 40 differs from the first lens 38A in that the position thereof in the optical axis direction 60 is fixed. The second lens 40 is a variable focal length lens and reduces the spherical aberration determined by the focal position 22 by varying the focal length according to the focal position 22.

The control unit 18 reduces the aberration determined by the focal position 22 of the excitation light 20 and reduces the spot diameter of the excitation light 20 at the focal position 22 by controlling the operation of the second drive mechanism 44. The control unit 18 stores table information mapping the focal position 22, the first driving quantity of the first drive mechanism 42A, and the second driving quantity of the second drive mechanism 44 to each other and drives the first drive mechanism 42A and the second drive mechanism 44 according to the table information.

The second embodiment provides the same advantage as the first embodiment.

### Third embodiment

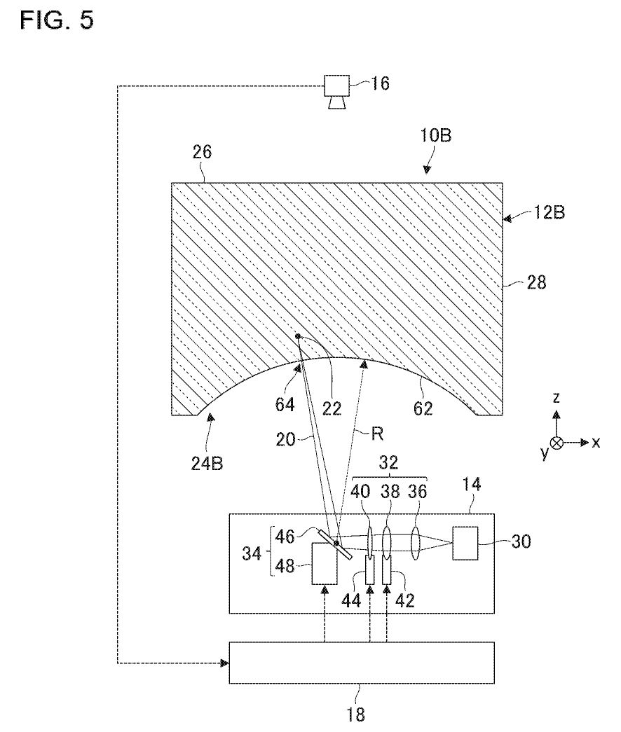

FIG. 5 schematically shows a configuration of a display apparatus 10B according to the third embodiment. The third embodiment differs from the first embodiment described above in that the first surface 24B of the display body 12B is configured to have a concave surface 62. The following description of the third embodiment highlights the difference from the first embodiment , and a description of common features is omitted as appropriate.

The display apparatus 10B is equipped with a display body 12B, the irradiation unit 14A, the sensor 16, and the control unit 18. The irradiation unit 14, the sensor 16, and the control unit 18 may be configured similarly to the first embodiment described above.

The display body 12B is equipped with a first surface 24B, the second surface 26, and the side surface 28. FIG. 5 shows a cross-section of the display body 12B on the xz plane. The first surface 24B has the concave surface 62 on which the excitation light 20 is incident. The display body 12B may be configured in the same way as the display body 12 according to the first embodiment except that the concave surface 62 is provided on the first surface 24B.

The concave surface 62 has a shape in which a distance R from the scan mirror 46 is constant and is configured to present a spherical surface centered at the scan mirror 46. As a result, the excitation light 20 can be caused to be incident perpendicularly on the concave surface 62 even if the irradiation direction of the excitation light 20 is inclined with respect to the z direction. In other words, the excitation light 20 can be caused to be incident perpendicularly on the concave surface 62 regardless of a change in the incidence position 64 even if an incidence position 64 of the excitation light 20 on the concave surface 62 is changed by driving the scan mirror 46. This reduces the aberration (e.g., astigmatism and coma aberration) caused by the incidence of excitation light 20 on the first surface of the display body at an angle.

In the case the scan mirror 46 is equipped with a first scan mirror and a second scan mirror, for example, the concave surface 62 may have a shape in which the first curvature in the first direction (e.g., the x direction) and the second curvature in the second direction (e.g., the y direction) differ. When the first scan mirror directs the excitation light 20 for a scan in the first direction (e.g., the x direction), for example, the radius of curvature of the concave surface 62 in the first direction may match the first distance from the first scan mirror to the concave surface 62. When the second scan mirror directs the excitation light 20 for a scan in the second direction (e.g., the y direction), the radius of curvature of the concave surface 62 in the second direction may match the second distance from the second scan mirror to the concave surface 62. When the excitation light 20 is reflected by the first scan mirror and then reflected by the second scan mirror before being incident on the concave surface 62, the first distance is greater than the second distance so that the concave surface 62 is configured in such a way that the radius of curvature in the first direction is greater than the radius of curvature in the second direction. The concave surface 62 may, for example, be configured to have an elliptical sphere surface. As a result, the excitation light 20 can be incident perpendicularly on the concave surface 62 regardless of a change in the incidence position 64 even if the first scan mirror and the second scan mirror are driven to vary the incidence position 64 of the excitation light 20 on the concave surface 62.

The display method according to the embodiment includes: a step of reflecting the excitation light 20 to excite the phosphor by using the scan mirror 46 toward the concave surface 62 of the display body 12B containing the phosphor; and a step of driving the scan mirror 46 to vary the incidence position 64 of the excitation light 20 on the concave surface 62. The display method may further include a step of driving the first lens 38 to vary the focal position 22. The display method may further include a step of driving the second lens 40 to reduce the aberration that varies with a change in the focal position 22.

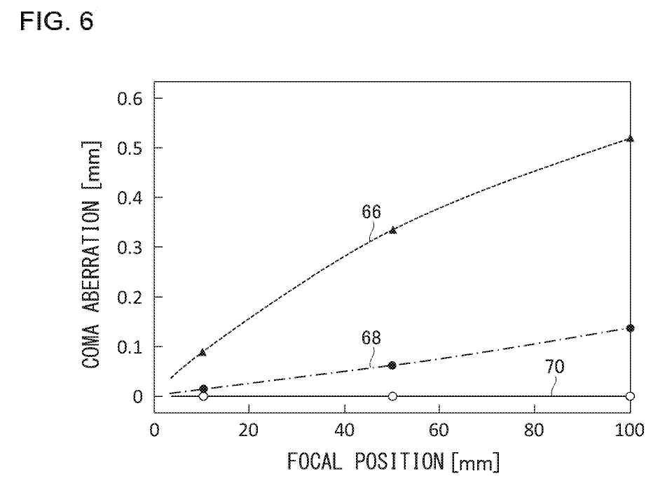

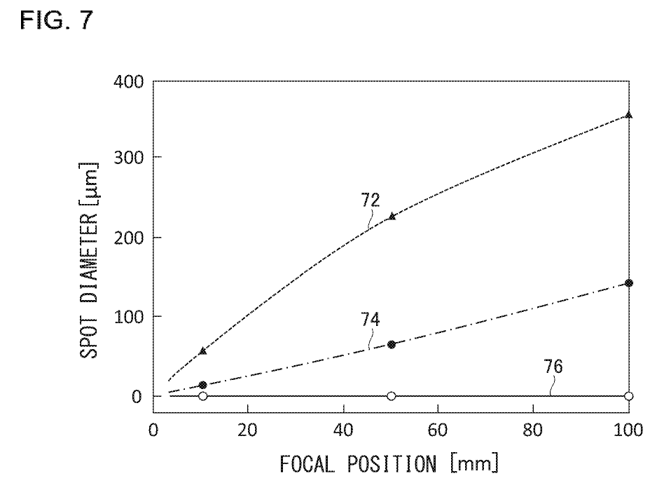

A description will now be given of advantages of the embodiment. FIG. 6 is a graph showing an example of coma aberration determined by the focal position 22 according to the exemplary embodiment and the comparative example. FIG. 7 is a graph showing an example of the spot diameter of the excitation light 20 determined by the focal position 22 according to the exemplary embodiment and the comparative example. The first exemplary embodiment indicated by solid lines 70, 76 is presented as a case where the concave surface 62 is provided on the first surface 24B of the display body 12B, and the second lens 40 for correcting the aberration is provided. The second exemplary embodiment indicated by chain lines 68, 74 is presented as a case where the concave surface 62 is provided on the first surface 24B of the display body 12B, while the second lens 40 for correcting the aberration is not provided. The comparative example indicated by dashed lines 66, 72 is, as in the comparative example related to the first embodiment, presented as case where the first surface 24 of the display body 12 is a flat surface and the second lens 40 for correcting the aberration is not provided.

In the first exemplary embodiment, the second exemplary embodiment, and the comparative example, the wavelength of the excitation light 20 is 405 nm, the beam diameter of the excitation light 20 parallelized by the collimating lens 36 is 100 mm, and the refractive index of the display body 12B is 1.51. In the first exemplary embodiment and the second exemplary embodiment, the distance from the scan mirror 46 to the concave surface 62 is 100 mm, and the radius of curvature of the concave surface 62 is 100 mm. In the first exemplary embodiment, the distance from the first lens 38 to the second lens 40 is 30 mm.

FIG. 6 shows the maximum value of coma aberration caused at the focal position 22. The horizontal axis of the graph represents the position in the depth direction from the first surface 24 or the concave surface 62 toward the second surface 26 when it is given that the position of the first surface 24 or the concave surface 62 of the display body 12B is 0 mm. In the comparative example indicated by the dashed line 66, it is seen that the amount of aberration increases as the focal position 22 deepens. In the second exemplary embodiment indicated by a chain line 68, it is seen that the amount of aberration is reduced compared to the comparative example. In the first exemplary embodiment indicated by the solid line 70, it is seen that the amount of aberration is reduced to almost zero (e.g., 1 μm or less) by combining the second lens 40 for aberration correction.

FIG. 7 shows the spot diameter (RMS, root mean square) of the excitation light 20 at the focal position 22. The horizontal axis of the graph shows, as in the case of FIG. 6, the position in the depth direction from the first surface 24 or concave surface 62 to the second surface 26 when it is given that the position of the first surface 24 or the concave surface 62 of the display body 12B is 0 mm. In the comparative example indicated by the dashed line 72, it is seen that the spot diameter increases as the focal position 22 deepens. In the second embodiment indicated by the dashed line 74, it is seen that the spot diameter is reduced compared to the comparative example. In the first exemplary embodiment indicated by the solid line 76, the spot diameter is controlled to be 2 μm or less, which is close to the diffraction limit, regardless of the focal position 22. This makes it possible to draw the stereoscopic image S with high definition and display a clearer stereoscopic image S compared to the comparative example.

The display apparatus 10B according to the third embodiment may be equipped with the irradiation unit 14A according to the second embodiment instead of the irradiation unit 14 according to the first embodiment. In other words, the display apparatus 10B may vary the depth position of the focal position 22 by varying the position of the first lens 38A in the optical axis direction 60.

The display apparatus 10B according to the third embodiment may not be equipped with the second lens 40 and the second drive mechanism 44 and may be configured in the same way as the second exemplary embodiment according to FIG. 6 and FIG. 7. In the case of the second exemplary embodiment, the advantage of reducing aberration is smaller than that of the first exemplary embodiment equipped with the second lens 40 and the second drive mechanism 44, but the aberration can be reduced, and the spot diameter at the focal position 22 can be reduced compared with the comparison example without the concave surface 62. This makes it possible to draw the stereoscopic image S with high definition and display a clearer stereoscopic image S compared to the comparative example.

The above embodiments are presented cases where the display apparatus 10, 10A, and 10B is equipped with the sensor 16. In alternative embodiments, the display apparatus 10, 10A, and 10B may not be equipped with the sensor 16. In this case, the display apparatus 10, 10A, and 10B may cause the first drive mechanism 42, 42A and the second drive mechanism 44 to operate according to the table information stored in advance in the control unit 18. The table information may include data indicating the first driving quantity and the second driving quantity determined by the focal position 22.

The present disclosure has been explained with reference to the embodiments described above, but the present disclosure is not limited to the embodiments described above, and appropriate combinations or replacements of the features shown in the examples presented are also encompassed by the present disclosure.

Some embodiments of the present disclosure will now be described.

The first embodiment of the present disclosure relates to a display apparatus including: a display body that contains a phosphor; a light source that outputs an excitation light to excite the phosphor; a first lens and a second lens that focus the excitation light on a focal position inside the display body; a first drive mechanism that drives the first lens to vary the focal position; and a second drive mechanism that drives the second lens to reduce aberration that varies with a change in the focal position.

In the first embodiment, the first lens and the second lens may be variable focus lenses, and the first drive mechanism and the second drive mechanism may vary a focal length of the variable focus lens.

In the first embodiment, the first lens may be a fixed focus lens, the second lens may be a variable focus lens, the first drive mechanism may vary a position of the fixed focus lens in an optical axis direction, and the second drive mechanism may vary the focal length of the variable focus lens.

In the first embodiment, the display apparatus may further include: a sensor that detects the focal position; and a control unit that controls an operation of at least one of the first drive mechanism or the second drive mechanism based on a detection result of the sensor.

The second embodiment of the present disclosure relates to a display method including: focusing an excitation light to excite a phosphor on a focal position inside a display body that contains the phosphor by using a first lens and a second lens; driving the first lens to vary the focal position; and driving the second lens to reduce aberration that varies with a change in the focal position.

The third embodiment of the present disclosure relates to a display apparatus including: a display body that contains a phosphor and has a concave surface; a light source that outputs an excitation light to excite the phosphor; a scan mirror that reflects the excitation light toward the concave surface; and a mirror drive mechanism that drives the scan mirror to vary an incidence position of the excitation light on the concave surface.

In the third embodiment, the concave surface may have a shape in which a distance from the scan mirror is constant.

In the third embodiment, the scan mirror may include a first scan mirror for directing the excitation light for a scan in a first direction and a second scan mirror for directing the excitation light for a scan in a second direction, and the concave surface may have a shape in which a first curvature in the first direction and a second curvature in the second direction differ.

In the third embodiment, the display apparatus may further include: a first lens and a second lens that focus the excitation light on a focal position inside the display body; a first drive mechanism that drives the first lens to vary the focal position; and a second drive mechanism that drives the second lens to reduce aberration that varies with a change in the focal position.

The fourth embodiment of the present disclosure relates to a display method including: reflecting an excitation light to excite a phosphor toward a concave surface of a display body that contains the phosphor; and driving the scan mirror to vary an incidence position of the excitation light on the concave surface.

What is claimed is:

1. A display apparatus comprising:
a display body that contains a phosphor;
a light source that outputs an excitation light to excite the phosphor;
a first lens and a second lens that focus the excitation light on a focal position inside the display body;
a first drive mechanism that drives the first lens to vary the focal position; and
a second drive mechanism that drives the second lens to reduce aberration that varies with a change in the focal position.

2. The display apparatus according to claim 1,
wherein the first lens and the second lens are variable focus lenses, and
wherein the first drive mechanism and the second drive mechanism vary a focal length of the variable focus lens.

3. The display apparatus according to claim 1,
wherein the first lens is a fixed focus lens,
wherein the second lens is a variable focus lens,
wherein the first drive mechanism varies a position of the fixed focus lens in an optical axis direction, and
wherein the second drive mechanism varies the focal length of the variable focus lens.

4. The display apparatus according to claim 1, further comprising:
a sensor that detects the focal position; and
a control unit that controls an operation of at least one of the first drive mechanism or the second drive mechanism based on a detection result of the sensor.

5. The display apparatus according to claim 1,
wherein the display body has a concave surface on which the excitation light is incident,
the display apparatus further comprising:
a scan mirror that reflects the excitation light toward the concave surface; and
a mirror drive mechanism that drives the scan mirror to vary an incidence position of the excitation light on the concave surface.

6. The display apparatus according to claim 5,
wherein the concave surface has a shape in which a distance from the scan mirror is constant.

7. The display apparatus according to claim 5,
wherein the scan mirror includes a first scan mirror for directing the excitation light for a scan in a first direction and a second scan mirror for directing the excitation light for a scan in a second direction, and
wherein the concave surface has a shape in which a first curvature in the first direction and a second curvature in the second direction differ.

8. A display apparatus comprising:
a display body that contains a phosphor and has a concave surface;
a light source that outputs an excitation light to excite the phosphor;
a scan mirror that reflects the excitation light toward the concave surface; and
a mirror drive mechanism that drives the scan mirror to vary an incidence position of the excitation light on the concave surface.

9. The display apparatus according to claim 8,
wherein the concave surface has a shape in which a distance from the scan mirror is constant.

10. The display apparatus according to claim 8,
wherein the scan mirror includes a first scan mirror for directing the excitation light for a scan in a first direction and a second scan mirror for directing the excitation light for a scan in a second direction, and
wherein the concave surface has a shape in which a first curvature in the first direction and a second curvature in the second direction differ.

11. A display method comprising:
focusing an excitation light to excite a phosphor on a focal position inside a display body that contains the phosphor by using a first lens and a second lens;
driving the first lens to vary the focal position; and
driving the second lens to reduce aberration that varies with a change in the focal position.
